(19) United States
(12) Patent Application Publication
(10) Pub. No.: US 2017/0139498 A1
(43) Pub. Date: May 18, 2017

(54) OPTICAL TOUCH DEVICE AND TOUCH DISPLAY DEVICE HAVING THE SAME

(71) Applicant: BOE TECHNOLOGY GROUP CO., LTD., Beijing (CN)

(72) Inventors: Xiangxiang Zou, Beijing (CN); Zezhou Yang, Beijing (CN); Chunfang Zhang, Beijing (CN); Zhongbao Wu, Beijing (CN)

(73) Assignee: BOE TECHNOLOGY GROUP CO., LTD., Beijing (CN)

(21) Appl. No.: 15/107,088

(22) PCT Filed: Dec. 28, 2015
(86) PCT No.: PCT/CN2015/099230

§ 371 Date: Jun. 21, 2016

(30) Foreign Application Priority Data
May 12, 2015 (CN) 201510239245.4

(51) Int. Cl. G06F 3/042

(52) U.S. Cl. CPC G06F 3/042

(57) ABSTRACT

The present application discloses an optical touch device comprising a light transmission layer comprising a first total internal reflection (TIR) surface and a second TIR surface facing the first TIR surface, a first side surface for connecting the first TIR surface and the second TIR surface on a first side, and a second side surface for connecting the first TIR surface and the second TIR surface on a second side opposite to the first side; a light source on a side of the first TIR surface distal to the second TIR surface for emitting a light beam, the light source is proximal to the first side; and a detector on the side of the first TIR surface distal to the second TIR surface, for detecting the light beam passed through the light transmission layer and transmitted into the detector, the detector is proximal to the second side. A first side angle between the first side surface and the first TIR surface is an acute angle. A second side angle between the second side surface and the first TIR surface is an acute angle.

### CROSS-REFERENCE TO RELATED APPLICATION

This application claims priority to Chinese Patent Application No. 201510239245.4, filed May 12, 2015, the contents of which are incorporated by reference in the entirety.

### FIELD

The present invention generally relates a touch control technology, and more particularly, to an optical touch control device and a touch display device having the same.

### BACKGROUND

Conventional touch devices can be generally categorized into resistive, capacitive, optical, sound wave, and electromagnetic designs. In recent years, touch devices have found a wide range of applications such as mobile phones, computer display panels, touch screens, satellite navigation devices, and digital cameras. Touch control technology has also been applied to large size display devices such as interactive whiteboard and digital signage. A conventional optical touch device provides light to a sensing area, such that a light sensing element can sense the position of a touch point. When the user's finger enters the sensing space, the optical detectors can detect the finger and thereby accomplish touch detection.

In conventional optical touch devices, light utilization efficiency is low. Typically, a utilization efficiency of less than 10% can be achieved in a conventional optical touch control device. Conventional touch devices require higher intensity light sources or a greater number of light sources. Thus, conventional touch devices demand more power consumption in order to achieve optimized touch control function.

### SUMMARY

The present invention provides an optical touch device comprising a light transmission layer comprising a first total internal reflection (TIR) surface and a second TIR surface facing the first TIR surface, a first side surface for connecting the first TIR surface and the second TIR surface on a first side, and a second side surface for connecting the first TIR surface and the second TIR surface on a second side opposite to the first side; a light source on a side of the first TIR surface distal to the second TIR surface for emitting a light beam, the light source is proximal to the first side; and a detector on the side of the first TIR surface distal to the second TIR surface, for detecting the light beam passed through the light transmission layer and transmitted into the detector, the detector is proximal to the second side.

Optionally, a first side angle between the first side surface and the first TIR surface is an acute angle.

Optionally, a second side angle between the second side surface and the first TIR surface is an acute angle.

Optionally, each of the first side angle and the second side angle is in the range of about 30° to about 50°.

Optionally, the first side angle and the second side angle are both approximately 38°.

Optionally, the optical touch device further comprises a first TIR layer on the first side and a second TIR layer on the second side.

Optionally, the light source is fully laminated onto the first TIR surface by a transparent optical adhesive.

Optionally, the detector is fully laminated onto the first TIR surface by a transparent optical adhesive.

Optionally, the light source is fully laminated onto the first TIR surface by a transparent optical adhesive, and the detector is fully laminated onto the first TIR surface by a transparent optical adhesive.

Optionally, the refractive index of the transparent optical adhesive is between around 1.3 and around 1.7.

Optionally, the refractive index of the transparent optical adhesive is 1.3.

Optionally, the optical touch device comprises a plurality of light sources and a plurality of the detectors, the light transmission layer further comprises a third side surface for connecting the first TIR surface and the second TIR surface on a third side, and a fourth side surface for connecting the first TIR surface and the second TIR surface on a fourth side opposite to the third side.

Optionally, the plurality of the light sources and the plurality of the detectors are arranged alternately and spaced apart, the plurality of the light sources and the plurality of the detectors are proximal to the first side, the second side, the third side, or the fourth side.

Optionally, the light source comprises a first printed circuit board and a light transmission terminal connected to the first printed circuit board, the light transmission terminal is on a side of the first printed circuit board proximal to the light transmission layer.

Optionally, the detector comprises a second printed circuit board and a light receiving terminal connected to the second first printed circuit board, the light receiving terminal is on a side of the second printed circuit board proximal to the light transmission layer.

Optionally, the light transmission layer is made of glass.

Optionally, the light utilization efficiency of the optical touch device from the light source to the detector is higher than 10%.

Optionally, the light utilization efficiency of the optical touch device from the light source to the detector is higher than 20%.

In another aspect, the present invention also provides a touch display device comprising an optical touch device described herein.

### BRIEF DESCRIPTION OF THE FIGURES

The following drawings are merely examples for illustrative purposes according to various disclosed embodiments and are not intended to limit the scope of the present invention.

FIG. 1 is a diagram illustrating the structure of a conventional optical touch device.

FIG. 2 is a cross-sectional view of an optical touch device according to an embodiment.

FIG. 3 is a cross-sectional view of an optical touch device according to another embodiment.

FIG. 4 is a top plan view of an optical touch control device according to an embodiment.

FIG. 5 shows variation of light utilization efficiency of optical touch control devices depending on the refraction index of the transparent optical adhesive and the angle between the side surface and the first total internal reflection surface according to some embodiments.

### DETAILED DESCRIPTION OF THE EMBODIMENTS

The disclosure will now describe more specifically with reference to the following embodiments. It is to be noted that the following descriptions of some embodiments are presented herein for purpose of illustration and description only. It is not intended to be exhaustive or to be limited to the precise form disclosed.

FIG. 1 is a diagram illustrating the structure of a conventional optical touch device. Referring to FIG. 1, the light source 3 in the embodiment includes a first printed circuit board 31 and a light transmission terminal 32 on the first printed circuit hoard 31. The detector 4 includes a second printed circuit board 41 and a light receiving terminal 42 on the second printed circuit board 41. The first and second printed circuit boards are edge laminated onto the light transmission layer 10. Prismatic films 6 are disposed on the interfaces between the light transmission layer 10 and the light source 3/the detector 4. Even with the prismatic films 6, the light utilization efficiency is still low, typically less than 10%.

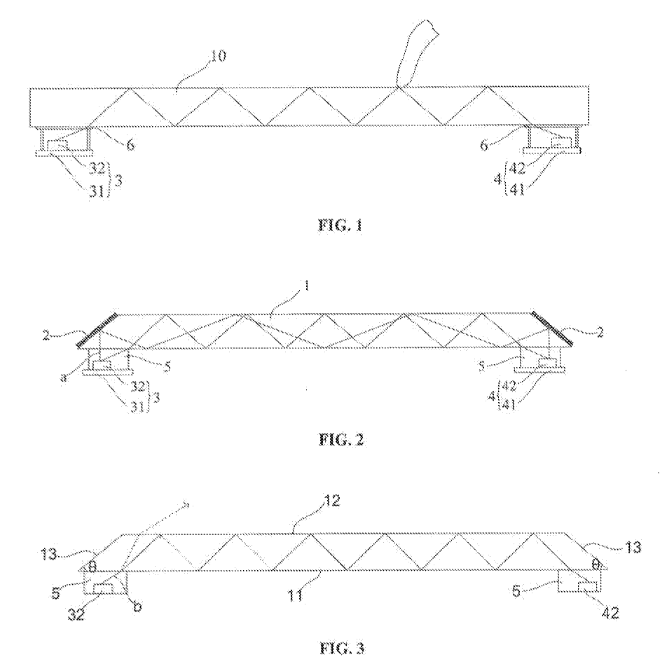

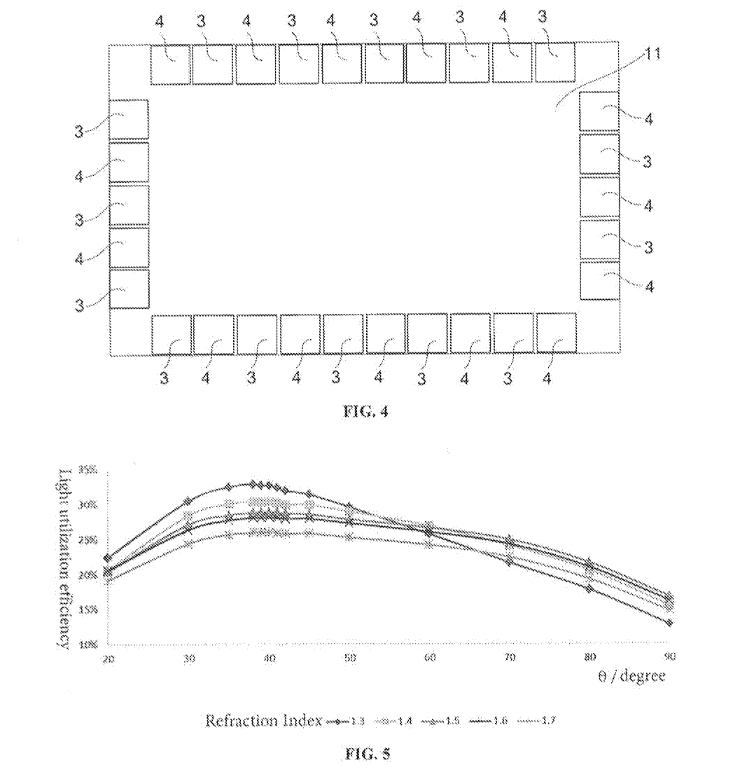

FIG. 2 is a cross-sectional view of an optical touch device according to an embodiment. FIG. 3 is a cross-sectional view of an optical touch device according to another embodiment. Referring to FIGS. 2 and 3, the optical touch device in the embodiments includes a light transmission layer 1, and at least a pair of a light source 3 and a detector 4. The light transmission layer 1 induces a first total internal reflection (TIR) surface 11 and the second TIR surface 12 facing the first TIR surface 11. The light source 3 is on a side of the first TIR surface 11 distal to the second TIR surface 12 for emitting a light beam. The detector 4 is on a side the first TIR surface 11 distal to the second TIR surface 12, for detecting the light beam passed through the light transmission layer 10 and transmitted into the detector 4. The sight transmission layer 1 further includes a first side surface for connecting the first TIR surface and the second TIR surface on a first side, and a second side surface for connecting the first TIR surface and the second TIR surface on a second side opposite to the first side. The light source 3 is proximal to the first side and the detector 4 is proximal to the second side. A first side angle between the first side surface end the first TIR surface is an acute angle. A second side angle between the second side surface and the first TIR surface is an acute angle.

In some embodiments, the first side angle equals to the second side angle. As shown in FIG. 3, both the first side angle and the second side angle are indicated as a side angle θ. In FIG. 3, the first side surface and the second side surface are both indicated as a side surface 13.

When the light source 3 emits light, the light enters into the first TIR surface 11 of the light transmission layer 1. The first TIR surface 11 and the second TIR surface 12 repeatedly totally reflects the light transmitted into the light transmission layer 1, and confines the light between the two TIR surfaces. The light travels through the light transmission layer 1, exits the first TIR surface, and is detected by the detector 4 disposed on the second side of the light transmission layer.

A portion of the light entering into the light transmission layer 1 (e.g., entering into the first TIR surface) does not satisfy the total internal reflection condition. By having the side angle θ (e.g., the first side angle and/or the second side angle) set to be a sharp angle, the portion of the light may be totally internal reflected by the side surface 13 (i.e., the first side surface), and transmitted through the light transmission layer 1. As shown in FIG. 2, for example, the light beam is reflected by the first side surface. Similarly, the second side surface on the opposition side of the light transmission layer 1 can reflect this portion of light after it travels through the light transmission layer 1 to the detector 4. As shown in FIG. 2, the light beam “a”, after it is transmitted through the light transmission layer 1, is reflected by the second side surface into the detector 4. Thus, due to the presence of the side surfaces, more light is available for total internal reflection inside the light transmission layer 1, and more light can be received and detected by the detector 4. The light utilization efficiency is thus enhanced.

In some embodiments, the side angle θ is in the range of about 30° to about 50°. For example, the first side angle can be an angle in the range of about 30° to about 50°. The second side angle optionally can also be an angle in the range of about 30° to about 50°. Optionally, the first side angle equals to the second side angle, and is in the range of about 30° to about 50°. In some embodiments, each of the first side angle and the second side angle is in the range of about 20° to about 90°, e.g., 20°-50°, 30°-60°, 20°-70°, 30°-70°, 20°-80°, 30°-80°.

In some embodiments, the optical touch device further includes a first TIR layer on the first side and a second TIR layer on the second side. Referring to FIG. 2, the side surface 13 (including the first side surface and the second side surface) includes a first TIR layer and a second TIR layer (both indicted as a TIR layer 2 in FIG. 2). As discussed above, a portion of the light entering into the light transmission layer 1 does not satisfy the total internal reflection condition. By having the first TIR layer, the portion of the light may be reflected back to the light transmission layer 1, and transmitted through the light transmission layer 1. Similarly, the second TIR layer on the opposition side of the light transmission layer 1 can reflect this portion of light to the detector 4 after it travels through the light transmission layer 1. As a result, more light is available for total internal reflection inside the light transmission layer 1, and more light can be received and detected by the detector 4. The light utilization efficiency is significantly enhanced.

In some embodiments, the light source 3 is fully laminated onto the first TIR surface 11, e.g., by a transparent optical adhesive. In some embodiments, the detector 4 is fully laminated onto the first TIR surface 11, e.g., by a transparent optical adhesive. In some embodiments, both the light source 3 and the detector 4 are fully laminated onto the first TIR surface 11, e.g., by a transparent optical adhesive 5 (FIGS. 2 and 3).

As discussed above, in a conventional optical device, the light source 3 and the detector 4 are both edge laminated onto the light transmission layer 10. It follows that there is air between the light source 3 and the light transmission layer 10. The light emitted from the light source 3 goes through air first before it enters into the light transmission layer 10.

In contrast, as shown in FIGS. 2 and 3, the light source 3 and the detector 4 are both fully laminated onto the first TIR surface 11 in the optical touch device according to the present disclosure. The light emitted from the light source 3 goes through a transparent optical adhesive 5 before it enters into the light transmission layer 1. The refraction index of the transparent optical adhesive 5 is higher than that of air. Consequently, the refraction angle of the light beam entering into and refracted by the first TIR surface is larger in a fully laminated optical touch device as compared to an edge laminated optical touch device. As shown in FIG. 3, the emitted light beam “b” passes through a transparent optical adhesive, and is refracted by the first TIR surface 11. The refracted light beam is indicated in the solid line. If the emitted light beam “b” passes through air and is refracted by the first TIR surface 11, the light beam would have a different refracted angle. The refracted light beam would be a light beam indicated in the dotted line in FIG. 3. As shown in FIG. 3, the refracted light in the solid line has a larger refraction angle as compared to the refracted light in the dotted line. In other words, in a fully laminated optical touch device, the incident angle of light beam “b” on the second TIR surface is larger. The incident angle of the light beam “b” in an edge laminated optical touch device is smaller. It is easier for a light beam having a larger incident angle on the second TIR surface to satisfy the total internal reflection condition. By having the light source 3 fully laminated onto the first TIR surface 11, more light becomes available for total internal reflection inside the light transmission layer 1. Similarly, by having the detector 4 fully laminated onto the first TIR surface 11, more light can be refracted out of the first TIR surface on the second side and received by the detector 4. The light utilization efficiency is thus further enhanced, without the need for a prismatic film 6.

The light transmission layer 1 can be made of any appropriate material. In some embodiments, the light transmission layer 1 is made of glass.

In some embodiments, the refractive index of the transparent optical adhesive 5 is between around 1.3 and around 1.7. Optionally, the refractive index of the transparent optical adhesive 5 is around 1.3.

FIG. 5 shows variation of light utilization efficiency of optical touch control devices depending on the refraction index of the transparent optical adhesive and the side angle according to some embodiments. In the example, the light transmission layer 1 is made of glass. The side angle θ is between 20° and 90° (e.g., 20°-30°, 30°-40°, 40°-50°, 50°-60°, 60°-70°, 70°-80°, and 80°-90°). The refractive index of the transparent optical adhesive 5 is between around 1.3 and around 1.7 (e.g., 1.3, 1.4, 1.5, 1.6. and 1.7). As shown in FIG. 5, in general the light utilization efficiencies of all optical touch devices are higher than 10%, most of which are higher than 20%. Using a side angle in the range of about 30° to about 50°, a light utilization efficiency between 24% and 33% can be achieved. When the side angle θ is about 38°, and the refractive index of the transparent optical adhesive 5 is 1.3, the light utilization efficiency of 33% can be achieved.

Thus, as compared to a conventional optical device, an optimized light utilization efficiency can be achieved using the optical touch devices as described herein. For example, in some embodiments, the light utilization efficiency using the optical touch devices described herein is higher than 10%, higher than 15%, higher than 20%, higher than 25%, higher than 30%, higher than 31%, higher than 32%, higher than 33%. In some embodiments, the light utilization efficiency using the optical touch devices described herein is in the range of 10%-40%, 20%-35%, 25%-35%, 20%-40%, 25%-40%, 30%-35%, or 30%-40%.

In some embodiments, the optical touch device includes a plurality of light sources 3 and a plurality of detectors 4. Optionally, the plurality of the light sources 3 and the plurality of the detectors 4 are disposed alternately and spaced apart around the edges of the light transmission layer 1 (e.g., four edges).

FIG. 4 is a top plan view of an optical touch control device according to an embodiment. Referring to FIG. 4, the optical touch device in the embodiment has four sides. Specifically, the light transmission layer 1 includes a first side surface for connecting the first TIR surface and the second TIR surface on a first side, a second side surface for connecting the first TIR surface and the second TIR surface on a second side opposite to the first side. In addition, the light transmission layer 1 includes a third side surface for connecting the first TIR surface and the second TIR surface on a third side, a fourth side surface for connecting the first TIR surface and the second TIR surface on a fourth side opposite to the third side. The first side surface forms a first side angle with the first TIR surface, the second side surface forms a second side angle with the first TIR surface, the third side surface forms a third side angle with the first TIR surface, the fourth side surface forms a fourth side angle with the first TIR surface. In the example, the first side angle, the second side angle, the third side angle, and the fourth side angle are all acute angles. As shown in FIG. 5, all four side angles are substantially the same, e.g., in the range of about 30° to about 50°.

The optical touch control device in FIG. 4 includes a plurality of the light sources 3 and a plurality of the detectors 4. The plurality of the light sources 3 are disposed on a side of the first TIR surface 11 distal to the second TIR surface 12 for emitting a light beam. The plurality of the detectors 4 are disposed on a side of the first TIR surface 11 distal to the second TIR surface 12 for detecting the light beam passed through the light transmission layer 1 and transmitted into the detectors 4. The plurality of the light sources 3 and the plurality of the detectors 4 are arranged alternately and spaced apart, and are proximal to the first side, the second side, the third side, or the fourth side. Accordingly, the optical touch control device includes a plurality of pairs of the light source 3 and the detector 4. Each pair of the light source 3 and the detector 4 are disposed proximal to two opposite sides of the optical touch control device. For example, a pair may have a light source 3 proximal to the third side and a corresponding detector 4 on the opposite positions proximal to the fourth side. Similarly, a pair may have a light source 3 proximal to the first side and a corresponding detector 4 on the opposite positions proximal to the second side. The plurality of the light sources 3 and the plurality of the detectors 4 may be arranged according to other appropriate ways.

In some embodiments, the light source 3 includes a first printed circuit board 31 and a light transmission terminal 32 connected to the first printed circuit board 31. For example, the light transmission terminal 32 can be placed on a side of the first printed circuit board 31 proximal to the light transmission layer 1.

In some embodiments, the detector 4 includes a second printed circuit board 41 and a light receiving terminal 42 connected to the second first printed circuit board 41. For example, the light receiving terminal 42 is on a side of the second printed circuit board 41 proximal to the tight transmission layer 1.

In another aspect, the present disclosure also provides a touch display device having an optical touch device described herein.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An optical touch device, comprising:
a light transmission layer comprising a first total internal reflection (TIR) surface and a second TIR surface facing the first TIR surface, a first side surface for connecting the first TIR surface and the second TIR surface on a first side, and a second side surface for connecting the first TIR surface and the second TIR surface on a second side opposite to the first side;
a light source on a side of the first TIR surface distal to the second TIR surface for emitting a light beam, the light source is proximal to the first side; and
a detector on the side of the first TIR surface distal to the second TIR surface, for detecting the light beam passed through the light transmission layer and transmitted into the detector, the detector is proximal to the second side;
wherein a first side angle between the first side surface and the first TIR surface, and a second side angle between the second side surface and the first TIR surface, each is an acute angle.

2. The optical touch device of claim 1, wherein each of the first side angle and the second side angle is in the range of about 30° to about 50°.

3. The optical touch device of claim 1, wherein the first side angle and the second side angle are both approximately 38°.

4. The optical touch device of claim 1, further comprising a first TIR layer on the first side and a second TIR layer on the second side.

5. The optical touch device of claim 1, wherein the light source is fully laminated onto the first TIR surface by a transparent optical adhesive.

6. The optical touch device of claim 1, wherein the detector is fully laminated onto the first TIR surface by a transparent optical adhesive.

7. The optical touch device of claim 1, wherein the light source is fully laminated onto the first TIR surface by a transparent optical adhesive, and the detector is fully laminated onto the first TIR surface by a transparent optical adhesive.

8. The optical touch device of claim 7, wherein the refractive index of the transparent optical adhesive is between around 1.3 and around 1.7.

9. The optical touch device of claim 8, wherein the refractive index of the transparent optical adhesive is 1.3.

10. The optical touch device of claim 1, wherein the optical touch device comprises a plurality of the light sources and a plurality of the detectors, the light transmission layer further comprises a third side surface for connecting the first TIR surface and the second TIR surface on a third side, and a fourth side surface for connecting the first TIR surface and the second TIR surface on a fourth side opposite to the third side;
the plurality of the light sources and the plurality of the detectors are arranged alternately and spaced apart, the plurality of the light sources and the plurality of the detectors are proximal to the first side, the second side, the third side, or the fourth side.

11. The optical touch device of claim 1, wherein the light source comprises a first printed circuit board and a light transmission terminal connected to the first printed circuit board, the light transmission terminal is on a side of the first printed circuit board proximal to the light transmission layer.

12. The optical touch device of claim 1, wherein the detector comprises a second printed circuit board and a light receiving terminal connected to the second first printed circuit board, the light receiving terminal is on a side of the second printed circuit board proximal to the light transmission layer.

13. The optical touch device of claim 1, wherein the light transmission layer is made of glass.

14. The optical touch device of claim 1, wherein the light utilization efficiency of the optical touch device from the light source to the detector is higher than 10%.

15. The optical touch device of claim 1, wherein the light utilization efficiency of the optical touch device from the light source to the detector is higher than 20%.

16. A touch display device comprising an optical touch device of claim 1.
